(19) United States
(12) Patent Application Publication
(10) Pub. No.: US 2023/0334283 A1
(43) Pub. Date: Oct. 19, 2023

(54) PREDICTION METHOD AND RELATED SYSTEM

(71) Applicant: Università degli Studi di Napoli "Federico II", Napoli (IT)

(72) Inventors: Francesco Piccialli, Napoli (IT); Salvatore Cuomo, Napoli (IT); Fabio Giampaolo, Napoli (IT); Edoardo Prezioso, Napoli (IT)

(21) Appl. No.: 17/815,737

(22) Filed: Jul. 28, 2022

(30) Foreign Application Priority Data
Apr. 13, 2022 (IT) 102022000007349

(51) Int. Cl. G06N 3/04; G06F 16/22; G06N 3/08

(52) U.S. Cl. CPC G06N 3/04; G06F 16/2237; G06N 3/08

(57) ABSTRACT

A method is described for predicting a plurality of univariate and/or multivariate time series (12) of time-varying values implemented by a prediction system of the plurality of time series (12).

### BACKGROUND OF THE INVENTION

### 1) Field of the Invention

The present invention relates to a prediction method, in particular a prediction method of a plurality of univariate and/or multivariate time series of time-varying values.

Moreover, the present invention refers to a prediction system of a plurality of univariate and/or multivariate time series of values varying over time.

### 2) BACKGROUND ART

The use of predictive models based on time series is known in many industrial, scientific, health, financial and research fields, in particular the design of predictive algorithms from geology to health care, from the management of traffic to industrial production, etc. which guarantee reliability and repeatability.

It is known how the prediction of time series and the simulation of future situations can allow dealing with critical situations more efficiently.

Economic and research investments are known on the study and development of machine learning methodologies and deep learning strategies to tackle complex problems, to try to reduce the redundancy of information sources, or the noise introduced by variables, and to provide robust forecast models.

The following patent documents are therefore known:
U.S. Pat. No. 6,735,580B1, which describes a forecasting system and related method implemented by the time series system for financial securities by means of a single recurring artificial network ANN; therefore, this prediction method does not allow to evaluate different characteristics of each data of the analyzed time series;
US2020143246 and US2019394083, which use a pipeline system for the prediction of time series data, allowing to obtain different predictions with different algorithms. Such obtained predictions are evaluated based on accuracy measures, and only the prediction deemed most accurate is used.

It is evident that the known methods and prediction systems are not able to allow an optimal management of multivariate models, of time series characterized by a high number of time-varying parameters, and of time series of different nature; methods and systems are also not known, which are capable of reducing the dimensionality of data through a coding technique, extracting useful information through single predictive procedures and collecting all data processed through a combiner to provide reliable and robust final predictions.

### SUMMARY OF THE INVENTION

Object of the present invention is solving the aforementioned prior art problems by providing a prediction method capable of providing solid and accurate predictions for a plurality of univariate and/or multivariate time series of time-varying values.

Another object of the present invention is providing a prediction system capable of implementing this prediction method.

The aforementioned and other objects and advantages of the invention, as will emerge from the following description, are achieved with a prediction method and related system such as those described in the respective independent claims. Preferred embodiments and non-trivial variants of the present invention are the subject matter of the dependent claims.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

### BRIEF DESCRIPTION OF THE DRAWINGS

The present invention will be better described by some preferred embodiments, provided by way of non-limiting example, with reference to the attached drawings, in which:

FIG. 1 shows a schematic diagram of an embodiment of the prediction method according to the present invention; and

FIGS. 2-4 show experimental results of the prediction method according to the present invention.

### DETAILED DESCRIPTION OF PREFERRED EMBODIMENTS

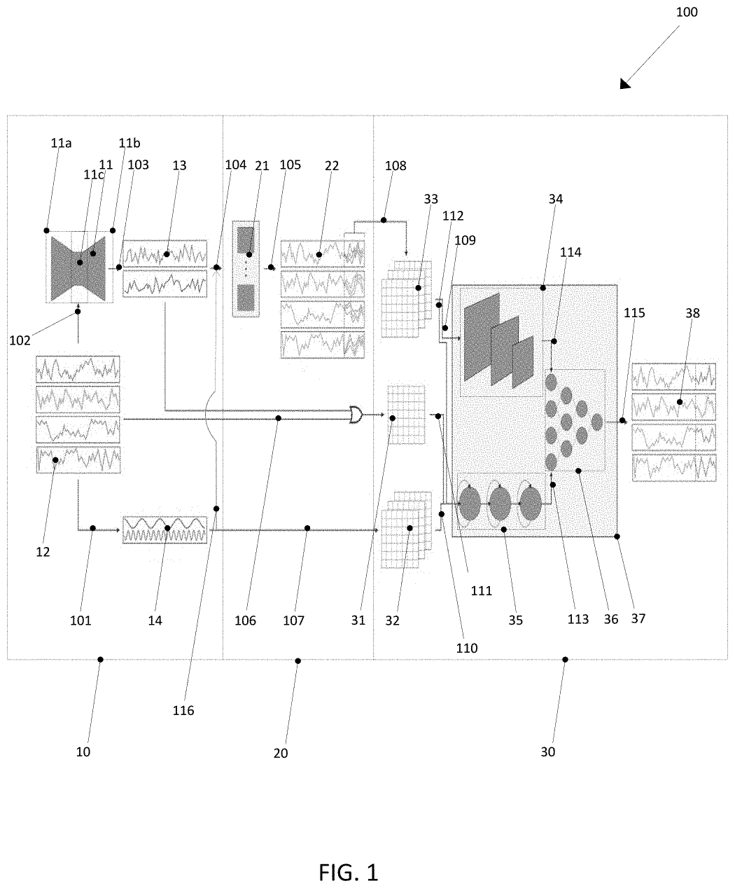

With reference to FIG. 1, a prediction system of a plurality of univariate and/or multivariate time series 12 of time-varying values comprises:
a computer with a processor equipped with a pipeline designed to increase the number of instructions under execution at the same time, without reducing the execution time, from the beginning to the completion of each instruction;
software comprising a first module 10 designed to compress the plurality of data related to the plurality of time series 12 and at the same time to reduce noise, a second module 20 designed to automatically calibrate combined preliminary prediction strategies related to the plurality of data received from the first module 10, and a third module 30 designed to combine information from the first module 10 and the second module 20.

These first, second and third modules 10, 20, 30 interact reciprocally asynchronously by means of the processor with pipeline.

The first module 10 consists of:
a data collector designed to collect and pre-process the plurality of data related to the plurality of time series 12, producing a set of structured data in relational form (dataset) grouped in a first matrix 31;
a data reducer, designed to provide a compressed representation of the plurality of data without loss of information, acting at the same time as a noise reducer, by means of a neural network with an automatic encoder structure (autoencoder) 11;
a sender designed to send a plurality of filtered and compressed data 13 by means of the data collector and the data reducer, to the second module 20 of the system.

Advantageously, the data collector performs a plurality of automatic analysis processes on the set of structured data in relational form (dataset), allowing to:
extract a plurality of information (seasonalities) 14 relating to the characteristics of the plurality of data related to the plurality of time series 12 coming from different sources, such as, for example, sensors, application programming interface (API), etc.; in particular, each datum of the plurality of data is provided with a sequence of characters N (timestamp) assigned to each datum by the system during the collection of the plurality of data, generating categorical characteristics of seasonality J (features) related to each datum, such as phase of day, day of week, weekdays or holidays, month, season, year, grouped in a second matrix 32;
establish the stationarity of the plurality of time series 12, by means of an Augmented Dickey-Fuller Test (ADF Test), capable of testing the stationarity of a time series 12 by verifying that

−1<1−γ<1λ≠0

in the model

Δyₜ=α+βt+γyₜ₋₁+δ₁δγₜ₋₁+δ₂Δγₜ₋₂+ . . . +δₚ₋₁Δγₜ₋ₚ₊₁+εₜ

If γ=0 with a p<0.05, the time series 12 is considered stationary; if the time series 12 is not stationary, the time series 12 is differentiated;
stabilize the variance of each datum of the plurality of data by means of a logarithmic logaritmica transformation wₜ=log_{b}(yₜ) without null values, or a Box-Cox transformation wₜ=yₜ^{λ}−1)/λ with null values.

Advantageously, the neural network automatic encoder (autoencoder) 11 of the reduction device (data reducer) is designed to provide a representation of the plurality of data by minimizing a distance function between the original data and the reconstructed data, avoiding information losses and simultaneously reducing the noise; in particular, the automatic encoder (autoencoder) 11 comprises an encoder 11a which compresses the plurality of data related to the plurality of time series 12 at its input, generating a latent space 11c with reduced dimensions designed to represent the plurality of filtered and compressed data 13, and a decoder 11b which reconstructs the plurality of data.

The data reducer performs a plurality of evolutionary algorithms, such as, for example, a Random Key Genetic Algorithm (RKGA) allowing to generate a neural network with a minimum reconstruction error of the plurality of data, in particular defined in mathematical terms:

X ∈ R^{N×M} the plurality of input data to the data reducer, where each data of the plurality of data is provided with a sequence of characters N (timestamp), and distinguished by initial characteristics M (features); and

X̅ ∈R^{N×K} the plurality of filtered and compressed data generated by the data reducer, and sent by the sending device (sender) to the second module 20, where each data of the plurality of filtered and compressed data is characterized by compressed characteristics K (features).

The second module 20 comprises a preliminary prediction component 21 designed to provide a plurality of preliminary predictions 22 of the plurality of filtered and compressed data 13 provided by the first module 10 in a preselected time interval, modularly composed of a plurality of algorithms: statistical, of machine learning, hybrids, etc.; in particular, this preliminary prediction component 21 receives as input a first combination of the plurality of filtered and compressed data (13) with the plurality of information (14) (seasonalities) X̅ ∈R^{N×(K+J)} with K<J coming from the device (sender), and consequently each algorithm of this plurality of algorithms receives as input ingresso X̅ ∈ R^{N×(K+J)}, and generates a plurality of preliminary predictions 22 as output, related to each time series 12, Ŷ ∈ R^{N×kP} with P number of predictors and k number of time series 12 to be predicted.

Each algorithm of the plurality of algorithms is focused on at least one characteristic of each datum of the plurality of data, producing preliminary predictions focused on the single characteristics of each datum of each time series 12, grouping them in a third matrix 33, therefore the modularity of the preliminary component allows to build a set of machine learning models

{Mⱼⁱ(X̅)}_{j=1 , . . . p,i=1, . . . K}

increasing the reliability, sensitivity and expansion of the predictive system.

Preferably the plurality of algorithms include:
statistical Exponential Smoothing (ETS) algorithm;
AutoRegressive Integrated Moving Average (ARIMA) algorithm;
linear regressors (LASSO, Ridge, Elastic NET);
tree algorithm (Random Forests, Boosted Trees);
Support Vector Regression (SVR) algorithm;
Artificial Neural Networks (ANN); and
hybrid algorithms (ARIMA-ANN, ETS-ANN).

The third module 30 is designed to produce a plurality of robust and highly reliable final predictions Ŷ ∈R^{F×T}, with F number of time intervals (timesteps) on which to provide the plurality of final predictions 38 and with T number of time series 12 whose final prediction 38 has to be obtained by automatically identifying, by means of an ensemble learning strategy, a second combination of data defined in mathematical terms X̅ ∈R^{N×(K+J+kP)} among the plurality of preliminary predictions 22 outgoing from the second module 20, the plurality of data relating to the plurality of time series 12, and the plurality of information 14 (seasonalities) extracted from the data collector of the first module 10; preferably, the third module 30 consists of a hybrid neural network 37 composed of:
at least one Convolutional Neural Network (CNN) 34, equipped with a plurality of convolutional layers 34 mutually connected and operating in parallel, preferably three convolutional layers, designed to receive as input the plurality of preliminary predictions 22 at the output of the second module 20;
at least one recurrent neural network 35 with Gated Recurrent Units (GRU) equipped with a plurality of recurrent layers 35, preferably two recurrent layers, designed to receive as input the plurality of preliminary predictions 22 output from the second module 20, the plurality of related data the plurality of time series 12, and the plurality of information 14 (seasonalities) extracted from the data collector of the first module 10;
at least one dense neural network 36 equipped with a plurality of fully and reciprocally connected dense layers, designed to combine information output from the convolutional neural network 34 and the recurrent neural network 35.

Advantageously, the hybrid neural network 37 of the third module 30 is optimized by means of an evolutionary algorithm (BRKGA) obtaining the plurality of accurate final predictions 38, optimizing the following parameters: learning rate, weight decay and size of the plurality of dense layers, recurrent and convolutional.

In particular, the convolutional neural network 34 performs discrete convolutions on the third matrix 33 of the plurality of preliminary predictions 22, generating matrices of weights that express the most relevant characteristics of each datum of the plurality of preliminary predictions 22, extracting the local patterns that link the different characteristics of each data. The recurrent neural network 35 is equipped with a loopback connection, allowing to keep a temporal memory of the sequentiality of the plurality of processed data, and gates (update gate and reset gate) which reduce the problem of the disappearance of the gradient, a known phenomenon that creates difficulties in the training of recurrent neural networks through error retro-propagation, autonomously deciding during a training phase which and how much information to forget, and the amount of previous memory to keep.

A prediction method 100 is also described, for the plurality of time series 12 of time-varying values implemented by the prediction system, the method comprising the steps of:
collecting the plurality of data related to the plurality of time series 12, in the set of data structured in relational form (dataset) and grouping 106 in the first matrix 31;
extracting 101 the plurality of information 14 (seasonalities) relating to the characteristics of the plurality of data related to the plurality of time series 12, by means of the data collector of the first module 10, and grouping 107 the plurality of information 14 (seasonalities) in the second matrix 32;
applying 102 the neural network with structure of automatic encoder (autoencoder) 11 on the plurality of data related to the plurality of time series 12, reducing the dimensionality of the plurality of data and eliminating noise;
generating 103 the plurality of filtered and compressed data 13 by means of the data reducer of the first module 10;
combining 116 the plurality of filtered and compressed data 13 with the plurality of information 14 (seasonalities) and obtaining the first combination of the plurality of filtered and compressed data 13 with the plurality of information 14 (seasonalities);
sending 104 the first combination of the plurality of filtered and compressed data (13) with the plurality of information (14) (seasonalities) by the sending device (sender) of the first module to the preliminary prediction component 21 of the second module 20;
generating 105 the plurality of preliminary predictions 22 in a preselected time interval, focused on the single characteristics of each data of the plurality of time series 12, producing a set of automatic learning models and grouping 108 the plurality of preliminary predictions 22 in the third matrix 33;
sending 109 to the convective neural network 34 of the third module 30 the plurality of preliminary predictions 22 outgoing from the second module 20;
sending 110, 111, 112 to the recurrent neural network 35 of the third module 30 respectively the plurality of data related to the plurality of time series 12, the plurality of information 14 (seasonalities) extracted from the data collector of the first module 10, and the plurality of preliminary predictions 22 outgoing from the second module 20;
combining, by means of the dense neural network 36 of the third module 30, the plurality of information produced at the output of the convective neural network 34 and the recurrent neural network 35 and sent 113, 114 to the dense neural network 36;
producing 115 the plurality of final, robust and highly reliable predictions 38.

Below are the experimental results obtained in relation to the use of five datasets:
electricity dataset, containing daily data of the energy consumption measured in KW, of 370 users in a time period from Jan. 1, 2012 to Dec. 31, 2014, in particular consisting of 320 series and 1096 observations;
SST dataset, containing data of temperatures measured daily in a time period from Jan. 1, 2000 to Dec. 31, 2019 on the surface of the Pacific Ocean using 67 buoys;
PeMS dataset, containing data relating to distances measured in miles, and traveled on California motorways in a time period from Mar. 14, 2021 to May 13, 2021, in particular consisting of 46 series and 1463 observations;
health care dataset, containing the daily number of bookings in hospitals for allergy and pulmonology tests in the Campania Region, and data related to meteorological conditions such as temperature, wind speed, and concentration of atmospheric pollution in the Campania Region over a period of time from May 1, 2017 to Apr. 30, 2019, in particular consisting of 328 observations;
ToIT dataset, containing data related to the hourly occupancy rate of street parking along six roads between Caserta and Naples, defined as the ratio between the number of occupied parking spaces and the total number of parking spaces in a given area, in a period of time from 4 December to 29 February, in particular consisting of 2099 observations.

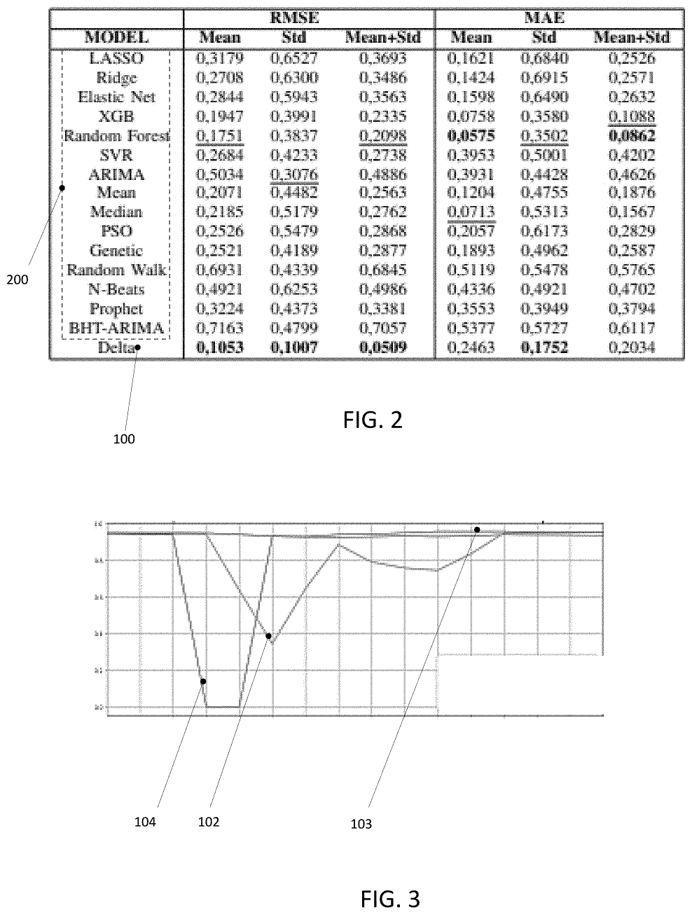

The performances of the method 100, according to the present invention, shown in a table of FIG. 2 with the word Delta, are evaluated and measured in terms of the Root Mean Square Error (RMSE) and of the average absolute error (Mean Absolute Error, MAE); in particular, FIG. 2 shows the table that provides a comparison in terms of Root Mean Square Error (RMSE) and Mean Absolute Error (MAE) between the 200 prediction methods used, such as: LASSO, Ridge, Elastic Net, XGB, Random Forest, SVR, ARIMA, Mean, Median, PSO, Genetic, Random Walk, N-beats, Prophet, BHT-ARIMA, and the 100 Delta method.

The table in FIG. 2 includes a first column related to the prediction methods 200 used, a second column related to the Root Mean Square Error (RMSE), each column divided into three columns corresponding to the mean (mean), to the standard deviation (std), and to the sum of the mean and the standard deviation (mean+std).

For each of the five datasets, a normalization of the errors committed by the 200 prediction methods and the 100 Delta method was performed, and then an average of the normalized values obtained for each of the five datasets used and arranged in the table in FIG. 2; from the table in FIG. 2, it can be seen that the 100 Delta method has:

relative to the Root Mean Square Error (RMSE), the mean values, the standard deviation values (std), and the sum of the mean and the stantard deviation (mean+std), are lower than the mean (mean), standard deviation (std), and sum of the mean and stantard deviation (mean+std) values obtained with the other 200 prediction methods used;
with regard to the Root Mean Square Error (RMSE), the standard deviation values (std) are lower than the standard deviation values (std) obtained with the other 200 prediction methods used.

These excellent results are obtainable because the hybrid neural network 37 of the third module 30 of the system that implements the method 100 is not affected by the presence of anomalous values in the time series, being equipped with a neural network with an automatic encoder structure (autoencoder) in the first module 10 of the system. FIG. 3 shows a first graph that allows evaluating the effectiveness of the neural network with an automatic encoder structure (autoencoder) of the first module 10, and consequently the reliability and robustness of the system and of the 100 Delta method, comparing, in a time interval from 26 November to 9 Dec. 2011, the prediction of temperature values relating to a 5n180w temperature sensor in a region surrounding an anomalous value, by a predictive method not using a neural network with an autoencoder structure 102, a predictive method using a neural network with an automatic encoder structure (autoencoder) 103, and the trend of an original datum 104 which has a depression in correspondence with the anomalous value.

Finally, to evaluate the calculation time of the 100 Delta method in relation to other predictive methods, in terms of Hardware, this was used to treat the dataset Electricity and SST CPU intelCore 19-9900K at 3.60 GHz, with 128 GiB of RAM and GeForce RTX 3070; IntelCore i7-3770 CPU at 3.40 GHz, with 16 GiB of RAM and GeForce RTX 970 was used for the PeMS dataset.

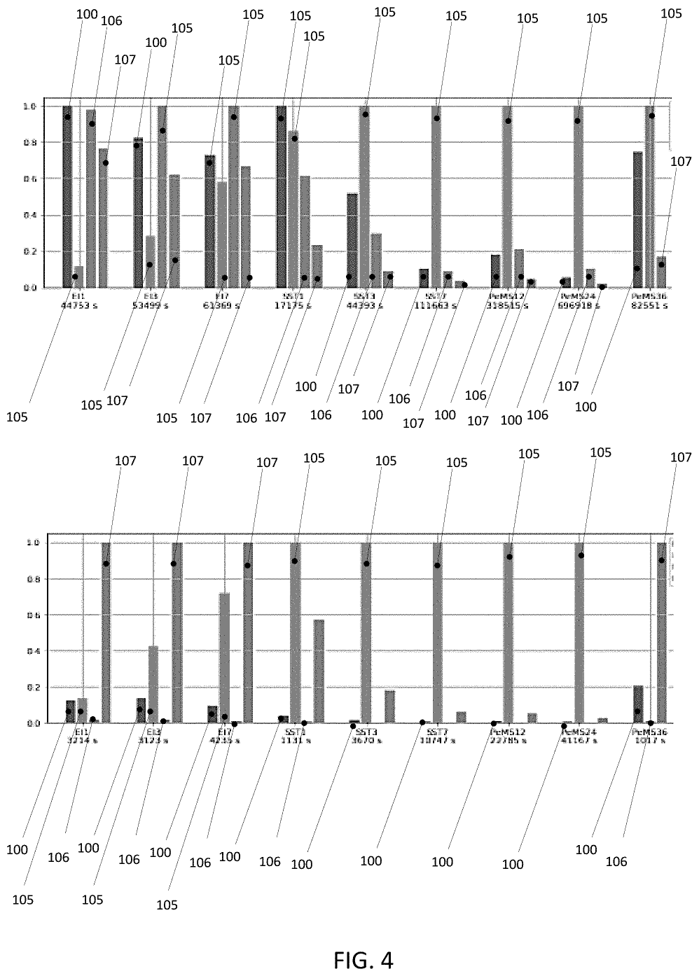

As shown in FIG. 4, a second graph presents a comparison of the computational times of the following predictive methods: BHT-Arima 105, Prophet 106, N-Beats 107, and of the 100 Delta method relative to the Electricity, SST and PeMs datasets.

The second graph, in FIG. 4, shows on the ordinate axis the times scaled with respect to a maximum time from 0 to 1, on the abscissa axis the relative dataset and the maximum time required: it can be seen that the Delta 100 method takes longer to compute for datasets with more data, but has a low forecast time.

The invention has the following advantages:
estimating future events on the basis of variable values over time and providing forecasts of future values of a temporal sequence;
supporting decision-making processes by providing forecasts to be used for long-term planning;
predicting the influx to a health facility allowing optimal management of resources, avoiding, for example, the overcrowding of the facility;
predicting the forecast of company sales, allowing executives to manage and monitor sales plans; and
estimating the future number of vehicles on the road, allowing to plan strategies to avoid traffic and potentially dangerous situations.

Some preferred forms of implementation of the invention have been described, but of course they are susceptible to further modifications and variations within the same inventive idea. In particular, numerous variants and modifications, functionally equivalent to the preceding ones, which fall within the scope of the invention as highlighted in the attached claims, will be immediately evident to those skilled in the art.

We claim:

1. A method for predicting a plurality of univariate and/or multivariate time series of time-varying values implemented by at least one prediction system of the plurality of time series, the method comprising the steps of:
collecting a plurality of data relating to the plurality of time series, in a set of data structured in relational form, namely a dataset, and grouping the dataset in a first matrix;
extracting a plurality of information, namely seasonalities, relating to the characteristics of the plurality of data related to the plurality of time series, by means of a data collector of a first module of the prediction system, and grouping the plurality of seasonalities in a second matrix;
applying a neural network with a structure of an automatic encoder on the plurality of data related to the plurality of time series, reducing the dimensionality of the plurality of data and eliminating noise;
generating a plurality of filtered and compressed data by means of a data reducer of the first module;
combining the plurality of filtered and compressed data with the plurality of seasonalities, and obtaining a first combination of the plurality of filtered and compressed data with the plurality of seasonalities;
sending the first combination by a sender of the first module to a preliminary prediction component of a second module of the prediction system;
generating a plurality of preliminary predictions in a preselected time interval, focused on the single characteristics of each datum of the plurality of time series, producing a set of automatic learning and grouping models of the plurality of preliminary predictions in a third matrix;
sending, to a convectional neural network of a third module of the prediction system, the plurality of preliminary predictions coming out of the second module;
sending, to a recurrent neural network of the third module, a second combination of data among the plurality of data related to the plurality of time series, the plurality of seasonalities extracted from the data collector of the first module, and the plurality of preliminary predictions output from the second module;
combining, by means of a dense neural network of the third module, the plurality of information produced as output by the convective neural network and by the recurrent neural network and sent to the dense neural network;
producing a plurality of robust and highly reliable final predictions.

2. The method of claim 1, wherein:
the plurality of data relating to the plurality of time series provided with a sequence of characters N, namely timestamps, and
characterized by initial characteristics M defined in mathematical terms as X ∈ R^{N×M} are arranged as input to the neural network with the structure of an automatic encoder of the reduction device, namely a data reducer;
the plurality of filtered and compressed data characterized by compressed characteristics K defined in mathematical terms as X̅ ∈R^{N×K} are generated by the data reducer;
the first combination, defined in mathematical terms as X̅ ∈ R^{N×(K+J)}, of the plurality of filtered and compressed data with the plurality of information seasonalities characterized by categorical characteristics of seasonality J, arranged at the input of the preliminary component of prediction of the second module;
the plurality of preliminary predictions defined in mathematical terms as Ŷ ∈ R^{N×kP} with P number of predictors and k number of time series to be predicted, at the output of the second module are disposed as input to the convectional neural network of the third module;
the second combination of data defined in mathematical terms as X̅ ∈ R^{N×(N×(K+J+kP)} among the plurality of data related to the plurality of time series, and the plurality of seasonalities and the plurality of preliminary predictions outgoing from the second module are disposed as input to the recurrent neural network of the third module;
the plurality of final reliability predictions defined in mathematical terms as Ŷ ∈ R^{F×T}, with F number of time intervals on which to provide the plurality of final predictions and with T number of the time series whose plurality of final predictions have to be obtained, are obtained by combining the plurality of information produced in output by the convectional neural network and by the recurrent neural network.

3. A prediction system for performing the method of claim 1, the system comprising:
a computer with a pipelined processor designed to increase the number of simultaneously executing instructions;
a software comprising the first module designed to compress the plurality of data related to the plurality of time series and at the same time to reduce the noise, the second module designed to automatically calibrate combined prediction strategies preliminary with respect to the plurality of data received from the first module, and the third module designed to combine the information coming from the first module and the second module.

4. The prediction system of claim 3, wherein the first module comprises:
the data collector designed to collect and pre-process the plurality of data related to the plurality of time series, extracting the plurality of seasonalities related to the categorical characteristics M of the plurality of data related to the plurality of time series coming from different sources, assigning to each datum of the plurality of data a sequence of characters N, and stabilizing the stationarity of the plurality of time series, by means of an Augumented Dickey-Fuller Test, ADF Test;
the data reducer, designed to provide a compressed representation of the plurality of data without loss of information, acting at the same time as a noise reducer, by means of the neural network with the structure of an autoencoder, and running a plurality of evolutionary algorithms;
the sender designed to send the plurality of filtered and compressed data by means of the data collector and the data reducer, to the second module of the system.

5. The prediction system of claim 3, wherein the second module comprises the preliminary prediction component modularly composed of a plurality of algorithms and designed to provide the plurality of preliminary predictions of the plurality of filtered and compressed data provided by the first module in a preselected time interval.

6. The prediction system of claim 3, wherein the third module consists of the hybrid neural network comprising:
a Convolutional Neural Network, CNN, equipped with a plurality of convolutional layers mutually connected and operating in parallel, designed to receive as input the plurality of preliminary predictions as output from the second module;
a Recurrent Neural Network with Gated Recurrent Units, GRU, equipped with a plurality of recurrent layers, designed to receive as input the plurality of preliminary predictions as output from the second module, the plurality of data related to the plurality of time series, and the plurality of seasonalities;
a Dense Neural Network, DNN, equipped with a plurality of dense layers completely and reciprocally connected, designed to combine the information output from the Convolutional Neural Network and from the Recurrent Neural Network.

7. The prediction system of claim 6, wherein the Hybrid Neural Network of the third module is optimized by means of an evolutionary algorithm, BRKGA, obtaining the plurality of final accurate predictions, optimizing the following parameters:
learning rate, decay of the weight and size of the plurality of dense, recurrent and convolutional layers.

8. The prediction system of claim 6, wherein the Convolutional Neural Network performs discrete convolutions on the third matrix of the plurality of preliminary predictions, generating matrices of weights expressing the most relevant characteristics of each datum of the plurality of preliminary predictions.
